(19) United States
(12) Patent Application Publication
(10) Pub. No.: US 2013/0210508 A1
(43) Pub. Date: Aug. 15, 2013

(54) CASINO-STYLE GAME INCORPORATING MULTIPLE WAGERING OPTIONS AT MULTIPLE INTERVALS DURING THE GAME

(71) Applicants: Long Phi Tran, Maple (CA); Ngoc Hue Vuong, Maple (CA)

(72) Inventors: Long Phi Tran, Maple (CA); Ngoc Hue Vuong, Maple (CA)

(21) Appl. No.: 13/574,682

(22) PCT Filed: Dec. 23, 2010
(86) PCT No.: PCT/CA10/02035

§ 371 Date: Oct. 9, 2012

Related U.S. Application Data
(60) Provisional application No. 61/290,068, filed on Jan. 22, 2010.

(51) Int. Cl. A63F 13/12

(52) U.S. Cl. CPC A63F 13/12
USPC 463/12

(57) ABSTRACT

The present invention is a game, computer program product, system and method that is operable to permit play of a casino-style, “in between” type game that provides for multiple wager options during various intervals in the play of a single hand or multiple-hand game. The game does not involve a dealer's hand, so the player makes wagers based solely on the odds and potential outcome of their own hand. The game is particularly suited to play on through mobile devices, in an online environment, and/or as electronic home entertainment. For example, the game may be played on wireless devices, cellular phones, laptop computers, gaming consoles, Internet connected devices, and other devices, as well as systems integrating said devices. Wagers and play instructions may be provided at the push of a button or by way of other communication means. Additionally, interaction between a player and a playing surface, whether the play is live or via any electronic means, may be incorporated into the game of the present invention to indicate wagers or instructions for play.

### FIELD OF INVENTION

This invention relates in general to the field of a game, and in particular to an in-between game involving multiple wager options based on a player's hand.

### BACKGROUND OF THE INVENTION

Modifications of known casino-style games are known in the art. These are generally modified versions of known casino-style games, such as Twenty-One or blackjack. The modification to the traditional game may facilitate an additional chance to gain winnings.

As an example, U.S. Pat. No. 5,154,429 discloses a modified method of playing blackjack or Twenty-One comprising a player playing the same hand against two or more successively dealt dealer's hands. Both the dealer and player are dealt cards. Play occurs against a dealer's first hand based upon the player's hand. Subsequent play occurs against the player's same hand and a dealer's second hand which is dealt after the dealer's first hand is removed from the table. Wagers may be placed against each of the dealer's first hand and any subsequent hands dealt to the dealer.

The modified games may further provide a means of placing wagers. For example, U.S. Pat. No. 5,275,416 which is a continuation-in-part of U.S. Pat. No. 5,257,810, discloses a game that involves a dealer's hand and a player's hand. This game is a modified version of blackjack. Three betting stations are incorporated in the play, a dealer betting station, a player betting station and a tie betting station. The object of the game is to wager with the appropriate betting station that represents the winning hand.

A modified version of Twenty-One, that allows for an additional wager than is incorporated into the traditional form of that game, is disclosed in U.S. Pat. No. 5,288,077. This patent discloses a game of Twenty-One that comprises a simultaneous side wager upon a progressive jackpot. The progressive jackpot winnings may be granted if a player's Twenty-One hand comprises a particular, predetermine arrangement of cards. The predetermined arrangement of cards may be allotted a worth relating to winnings of all, or apart of, the amount showing in the progressive jackpot. At the same time the player may be granted winnings based upon the player's hand and the traditional rules of Twenty-One, whereby the player hand is compared to the dealer's hand.

### SUMMARY OF THE INVENTION

In one aspect, the present disclosure relates to a method of an in-between game playable upon an electronic device, wherein a player is provided with multiple options to wager characterized in that the method comprises the steps of: the player making one or more pre-dealing wagers prior to any cards being provided to the player; providing at least two cards to the player; and the player determining if the at least two cards represent a playable hand, resulting in the player communicating a request to take one or more of the following steps: pushing; splitting; making a post-dealing wager; or surrendering.

In another aspect, the present disclosure relates to an online gaming system for playing an in-between game involving multiple wager options, characterized in that the Internet gaming system further comprises: one or more servers operable to store data; and a device including a screen and an input means operable to access an online connection and further linked to the one or more servers, said device further being operable to function with the one or more servers to: transfer data from the one or more servers to the device to operate the in-between game to: offer one or more pre-dealing wagers to a player prior to any cards being provided to the player and to communicate the one or more pre-dealing wagers chosen by a player to the server application; provide at least two cards to the player; and accept a request communication from the player, upon the player determining if the at least two cards represent a playable hand, to take one or more of the following steps: pushing; splitting; making a post-dealing wager; or surrendering.

In yet another aspect, the present disclosure relates to a computer program product tangibly embodied on a computer readable medium, for use on a server computer, characterized in that the computer program product comprises: a computer useable medium; and computer readable program code recorded or storable in the computer useable medium, the computer readable program code defining a server application on the server computer that is operable on the server computer to: offer one or more pre-dealing wagers to a player prior to any cards being provided to the player and to communicate the one or more pre-dealing wagers chosen by a player to the server application; provide at least two cards to the player; and accept a request communication from the player, upon the player determining if the at least two cards represent a playable hand, to take one or more of the following steps: pushing; splitting; making a post-dealing wager; or surrendering.

In still another aspect, the present disclosure relates to a method of playing an in-between game wherein a player is provided with multiple options to wager, characterized in that the method comprises the steps of: one or more pre-dealing wagers being made by the player prior to any cards being provided to the player; providing at least two cards to the player; the player determining if the at least two cards represent a playable hand, resulting in one of the following steps: determining the at least two cards are not a playable hand and a determining one of the following actions based on the at least two cards and the one or more pre-dealing wagers: making a pre-dealing wager payout to the player and ending the game; or ending the game; determining the at least two cards are a playable hand and taking the following steps: providing the player with the option to make one or more post-dealing wagers; and dealing at least one additional card to the player; and determining any wager payout to the player, or losses by the player, based upon the at least two cards, the at least one additional card, the one or more pre-dealing wagers and the one or more post-dealing wagers, having one of the following results: making a payout to the player; or receiving payment from the player.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1a is a gaming table layout of an embodiment of the present invention.

FIG. 1b is a player gaming layout that may be incorporated in a gaming table of an embodiment of the present invention.

FIG. 1c is a gaming table layout of an embodiment of the present invention.

FIG. 1d is a player gaming layout that may be incorporated in a gaming table of an embodiment of the present invention.

FIG. 1e is a gaming table layout of an embodiment of the present invention.

FIG. 1f is a player gaming layout that may be incorporated in a gaming table of an embodiment of the present invention.

FIG. 1g is a gaming table layout of an embodiment of the present invention.

FIG. 1h is a player gaming layout that may be incorporated in a gaming table of an embodiment of the present invention.

FIG. 1i is a gaming table layout of an embodiment of the present invention.

FIG. 1j is a player gaming layout that may be incorporated in a gaming table of an embodiment of the present invention.

FIG. 1k is a gaming table layout of an embodiment of the present invention.

FIG. 1l is a player gaming layout that may be incorporated in a gaming table of an embodiment of the present invention.

FIG. 1m is a gaming table layout of an embodiment of the present invention.

FIG. 1n is a player gaming layout that may be incorporated in a gaming table of an embodiment of the present invention.

FIG. 2a is a front perspective view of a gaming layout for a casino gaming device embodiment of the present invention.

FIG. 2b is a front perspective view of a gaming layout for a casino gaming device embodiment of the present invention.

FIG. 2c is a front perspective view of a gaming layout for a casino gaming device embodiment of the present invention.

FIG. 2d is a front perspective view of a gaming layout for a casino gaming device embodiment of the present invention.

FIG. 2e is a front perspective view of a gaming layout for a casino gaming device embodiment of the present invention.

FIG. 3a is a flow diagram of the order of play of an embodiment of the present invention for multiple players to the point of the second card being dealt in.

FIG. 3b is a flow diagram of the order of play of an embodiment of the present invention after a second card is dealt and the hand is deemed playable.

FIG. 4 is a flow diagram of the order of play of an embodiment of the present invention after a second card is dealt and the hand is not deemed playable.

FIG. 5 is a flow diagram of the order of play of an embodiment of the present invention if the first and second cards are not deemed eligible for a perfect wager.

FIG. 6 is a flow diagram of the order of play of an embodiment of the present invention if the first and second cards are a pair.

FIG. 7 is a flow diagram of the order of play of an embodiment of the present invention if the first and second cards are eligible for a perfect wager but the player does not choose to make a perfect wager.

FIG. 8 is a flow diagram of the order of play of an embodiment of the present invention if the first and second cards are a pair and a triple bonus wager is not offered.

FIG. 9 is a flow diagram of the order of play of an embodiment of the present invention whereby a third card is dealt and resultant play ensues.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a game, computer program product, system and method that is operable to permit play of a casino-style, “in between” type game that provides for multiple wager options during various intervals in the play of a single hand or multiple-hand game. The wager options include one or more wagers relating to the outcome of whether at least a third card shall have a value that is in between a first card and a second card. The game in one aspect thereof does not involve a dealer's hand, so the player makes wagers based solely on the odds and potential outcome of their own hand.

The game is particularly suited to play on or through mobile devices, in an online environment, and/or as electronic home entertainment. For example, the game may be played on wireless devices, cellular phones, laptop computers, gaming consoles, Internet connected devices, and other devices. Wagers and play instructions may be provided at the push of a button or by way of other communication means. Additionally, interaction between a player and a playing surface, whether the play is live or via any electronic means, may be incorporated into the game of the present invention to indicate wagers or instructions for play.

The present invention may offer a player the option to place multiple wagers during the play of a single hand, such as, for example six different wager options at various intervals during a hand. Such wagers may be placed a various points in play. Additionally, the player may have multiple options to increase wagers, or to withdraw any wager before the outcome of the hand is determined. The player may also have the opportunity to surrender and consequently recoup a portion of the possible full winnings, such as, for example, half of the player's initial wager.

Embodiments of the present invention may offer the player an option to choose to play for money, to have “free play”, or to play for any type of credits. Play for money may require that the embodiment of the present invention be connected to the Internet, or other networked environment operable to host transfers of money from a player's bank account or credit card to a gaming account of the present invention that is relevant to the player. A skilled reader will recognize that the gaming account may be of a variety of types and be governed by a variety of parameters, including parameters that cause the present invention to comply with relevant legislation or regulations.

A benefit of the present invention over the prior art is that the multiple wagering options are provided that are not available in prior art games. In traditional card games of the prior art, such as blackjack, a player may have only two opportunities to place a wager occurring at two different intervals during the course of a single hand. The first opportunity may be before each hand begins and the second opportunity may be before another card has been drawn in a two card hand, which is commonly known as the option to “double down”. The game of the present invention may provide the player with a greater sense of control and strategy. This may be achieved by the present invention without complicating the process of play of the game.

Another benefit of the present invention over the prior art may be that the sense of control and strategy may be further augmented by the fact that the present invention does not pit the player against the dealer. In traditional casino-style games, such as Twenty-One or blackjack, the player's cards are compared to the dealer's hand. The present invention allows the player to wager based solely on the possible outcomes of their own hand. The player may closely control his or her risk or return ventures.

Yet another benefit of the present invention over the prior art is that the set-up of the “in-between” game and the options for play, that include play online and/or through a mobile device, may permit the game to proceed at a faster pace than prior art games.

The present invention may involve game play whereby a player may place an initial wager before the first card is dealt. The initial wager may be called a “bet wager” in some embodiments of the present invention. The player may have an additional option to place a “bonus” wager before the first card is dealt. A first and second card may be dealt face up to each player in turn.

Multiple players may engage in the game of the present invention, such as, for example six players. One or more standard decks of 52 cards may be utilized in the game. The cards may be ordered or ranked for the purpose of the game from lowest to highest as Ace (representing a 1 (one)), 2 (two), 3 (three), 4 (four), 5(five), 6 (six), 7 (seven), 8 (eight), 9 (nine), 10 (ten), Jack, Queen, King. In some embodiments of the present invention upto 8 decks may be utilized in the game. A skilled reader will recognize that other amounts of decks of cards, including fewer than eight decks or more than eight decks may be utilized in some embodiments of the present invention.

At the point before a third card is dealt the player may decide if the third card, that will be dealt face up to each player, will have a value that falls between the values of the first and second cards. For example, should a player be dealt a 9 as a first card and a King as a second card. Before the third card is dealt the player may determine if the third card to be dealt to them will fall between a 9 and a King. In such a case the player is aiming to be dealt a 10, Jack, or Queen. A skilled reader will recognize that this example of two cards is but one example of a variety of two card combinations that a player may be dealt. His decision at this point, as to whether to wager that the third card will fall between the values of the first and second cards, may be related to the values of the first two cards.

Before the third card is dealt a player may decide to enhance their initial wager or surrender. The choice to surrender may cause the player to receive a portion of their initial wager, such as, for example half their initial wager. The third card may be dealt face up after this wagering. At this point all wagers will be settled with the players, whether these result in winnings or losses for the players.

In one embodiment of the present invention the wagering options of each player may include the following: (i) an initial wager made before the first card is dealt; (ii) a “bonus” wager made before the first card is dealt, being a wager on the odds of being dealt pairs or and Ace/King combination; (iii) a “triple bonus” wager made after the second card is dealt and before the third card is dealt, being a wager that may be made after a player is dealt pairs whereby the player is wagering a triple bonus based on the odds of being dealt a similar card as the third card (for example, if a player is dealt an 8 as a first card, an 8 as a second card, he may wager a triple bonus based on being dealt an 8 as the third card); (iv) a “perfect” wager made after the second card is dealt and before the third card is dealt, being a wager option available if the values of the first and second cards have one value between them that the third card will be the of the value between the values of the first and second cards (for example such as a first card that is a 9 and a second card that is a Jack, a win on a perfect wager will occur if the third card is a 10); (v) a “double down” wager made after the second card is dealt and before the third card is dealt, being a wager based upon the odds that the third card will be between the values of the first and second cards based on the favourability of the first and second cards already dealt; and (vi) a “surrender” wager after the second card is dealt and before the third card is dealt, being a diminishment of a wager to a portion of the initial wager, such as, for example half of the initial wager.

A player is required to make an initial wager. After the initial wager is made, a player may make any of the other available wagers in accordance with either his risk assessment, such as occurs for a bonus wager to be placed prior to any cards being dealt, or in accordance with the first and second cards dealt to him.

As an additional benefit over the prior art, the wager options of the present invention may encourage players to play the game more often and for a longer period of time. Traditional casino-style games do not offer as many wager options, or as wide a variety of wager options, or wager options occurring at as many points during the play of a single hand.

As a further benefit over the prior art, the wager options of the present invention may be particularly ideal for online, mobile, and electronic home versions of the game. The wager options may offer increased strategizing and payout scenarios. A player may execute these in a variety of means, such as through the push of a button when playing remotely, through interaction with the gaming table, or through communication with a dealer.

In one embodiment of the present invention wagers may result in winnings or losses in the following manner. After placement of an initial wager by each player electing to play, as well as an option to place a “Bonus” wager, two cards may be dealt face up to each player in turn. After receiving the second card, the “Bonus” wager, will be paid based on the pay table and losing “Bonus” wagers are immediately collected by the dealer. A Bonus wager is payable to the player if the player is dealt a first and second card that are either pairs or are an Ace/King combination. All other first and second card combinations are deemed to be losing.

Once the “Bonus” wager is paid, each player in turn decides if they would like to “Surrender”, or continue playing. The aim of the players at this point is to be dealt a third card having a value between the value of the first card dealt and the second card dealt. The wagering option to surrender may facilitate a player's prolonging his participation in multiple hands of the game. The option to surrender may also provide the player with a sense of strategic control.

A player cannot continue to play, and therefore cannot be dealt a third card, if the values of first and second cards are consecutive. For example, if a player is dealt a card having a value of 10 as the first card and/or a card having a value of 9 as the second card, the player will take back their initial wager (which the player will now “Push”—the activity of taking the “Push” option, can increase the player's odds), and if the “Bonus” wager is placed then the player will lose the wager.

If the first and second cards dealt to a player have only one possible value that could lie between them, the player has a perfect wager option. For example: if the first card has a value of 10 and the second card has a value of 8, then a perfect wager may be placed by the player. The player will be aiming for a card having the value of 9 to be the third card dealt. If a player is dealt a card that does not have the value of 9, the player loses and must forfeit his wager. The perfect wager opportunity that a player may utilize in the present invention may allow the player to maximize his or her return based upon the outcome of one card.

Prior to a third card being dealt, the player may not make a double down wager for equal or less value than the initial wager. The decision making sequence of the present invention, facilitated by the wager options, allows the player to enhance their risk/return tolerance throughout the hand.

If the third card dealt to a player is of a value that is between the values of the first and second cards dealt to the player the player may be deemed to have won. Winnings based on particular wagers may be determined in accordance with the rules of each wager. Wins may be paid to a player once all players have been dealt a third card and thereby completed their hands. The only hand where an initial wager and a bonus wager are paid is when the player has an ACE for the first card and KING for the second face card.

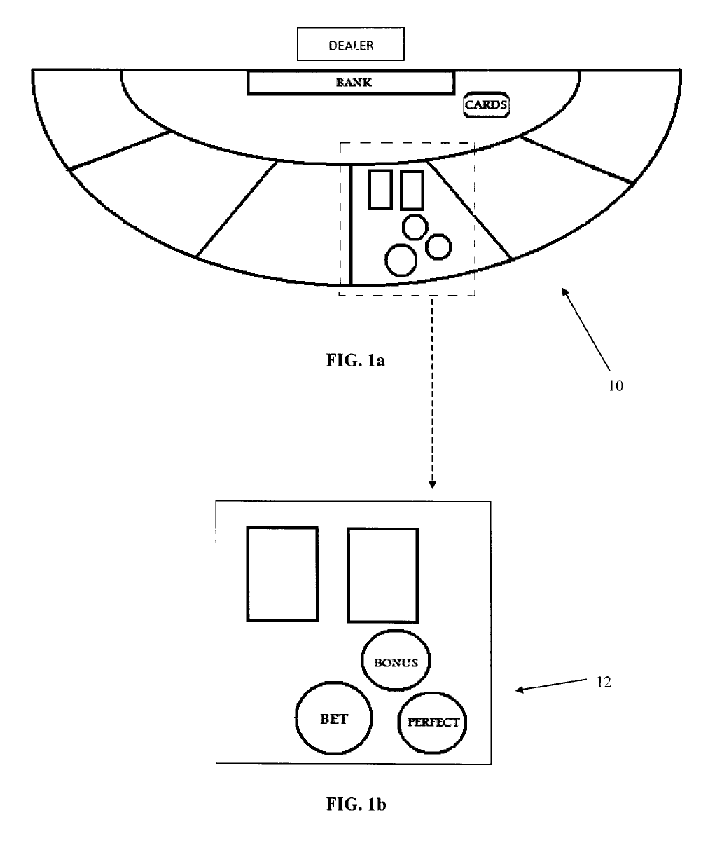

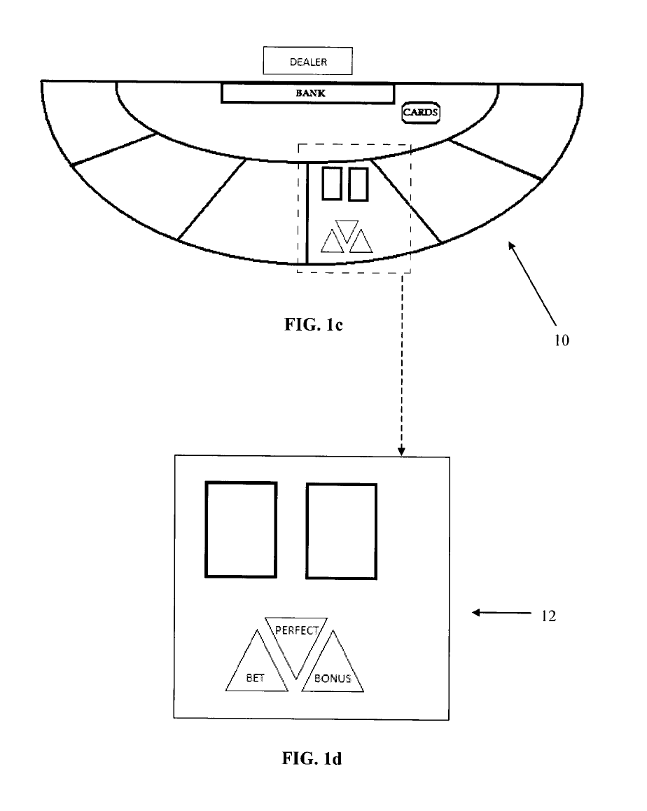

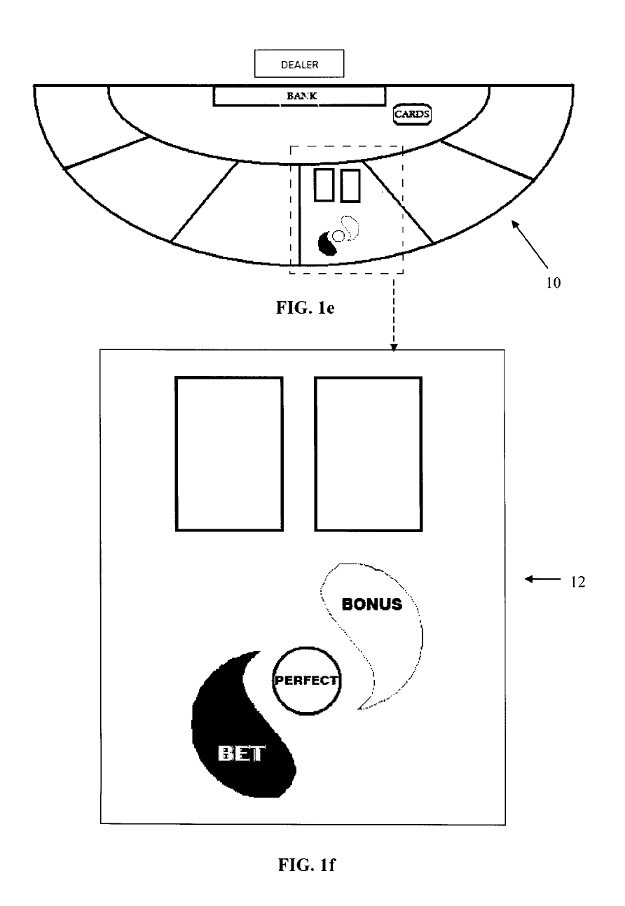

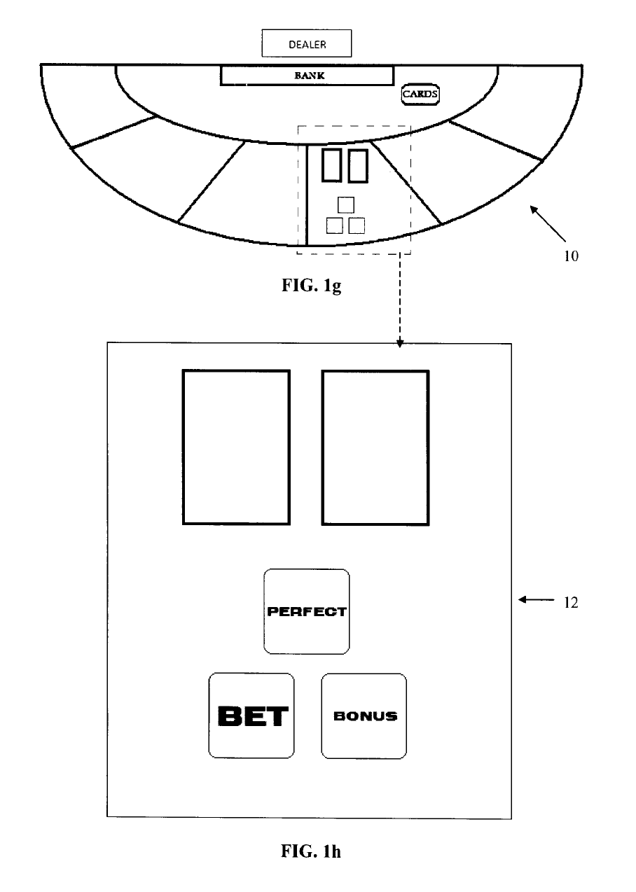

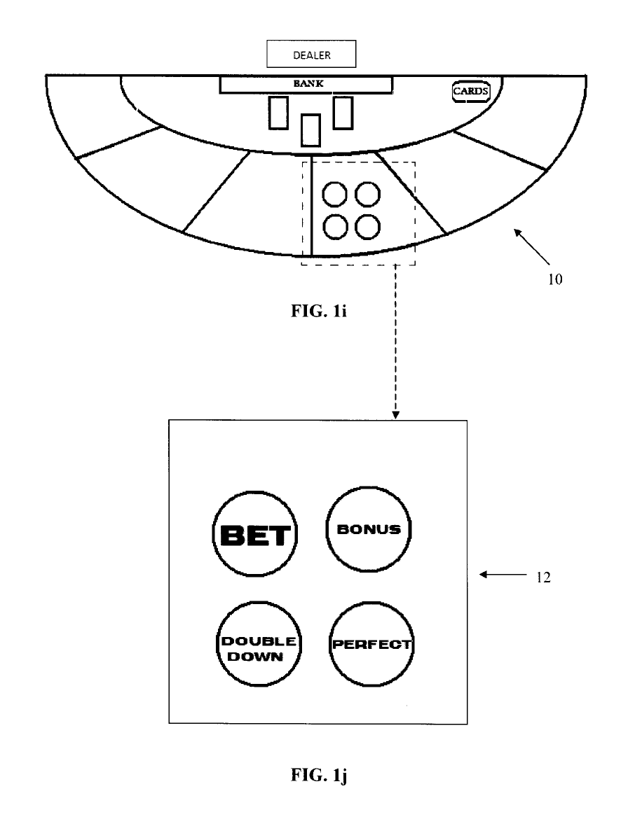

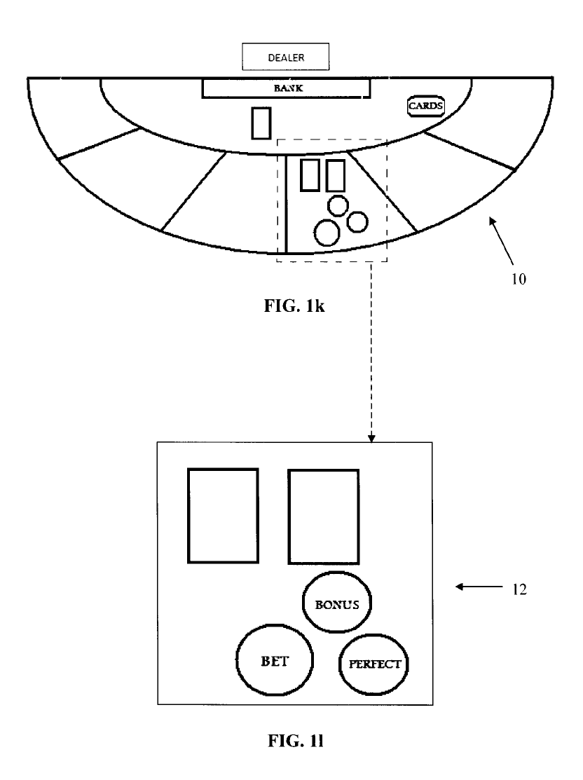

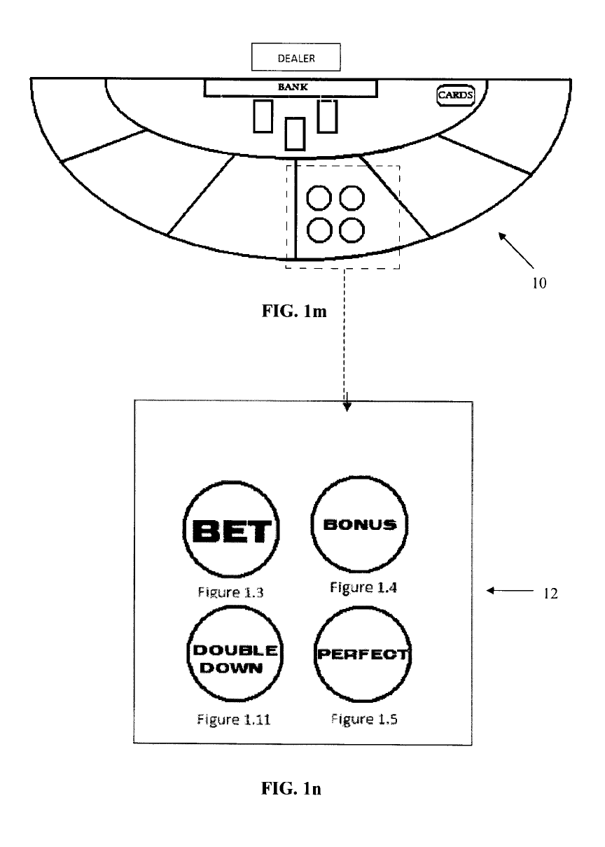

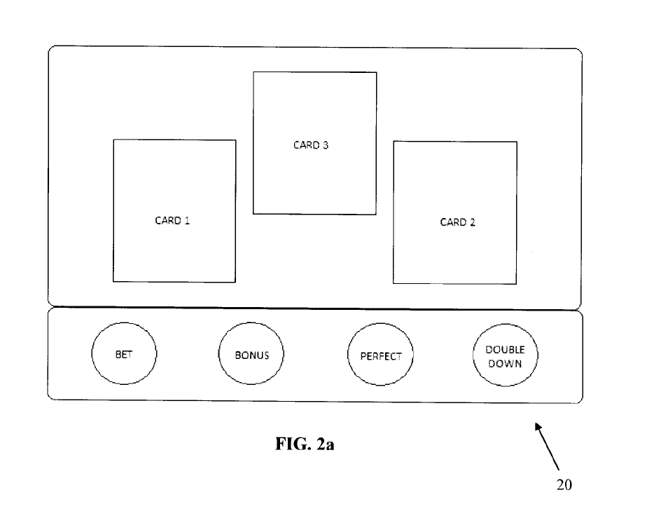

The methods of the present invention may be implemented on a casino-style gaming table 10 having one or more areas for the play of each player 12, as illustrated in FIGS. 1a-1n. The playing surface is of a gaming table may preferably be covered in coloured felt, but a variety of other surfaces and/or surface coverings may be utilized in embodiments of the present invention. The playing surface may be designed to accommodate any number of players. For example, six players are depicted as a grouping by FIG. 1a, since that is the generally considered to be the maximum number of players that can be efficiently managed by a single dealer in the present invention.

A dealer or controller station may be positioned opposite of the players so that the dealer can observe the players. The dealer station may include a chip area to store chips, tokens, coins, or bills.

Areas may be indicated on the gaming table for the play of each individual player and such areas may accommodate various configurations of card placements by way of card areas as well as configurations of wagers as wager areas to indicate specific wagers, such as, for example an initial wager, a perfect wager, and/or a bonus wager. The wager areas may be denoted by words, such as, for example, “BET” to indicate an initial wager, “PERFECT” to indicate a perfect wager, and/or “BONUS” to indicate a bonus wager.

Many aspects of the individual player areas and whole gaming table configurations may differ between embodiments of the present invention. The number of wager areas provided on the table may vary. Additionally, the position and shapes of the card areas and the wager areas may vary. Also, the manner of dealing the cards, whether the cards are provided with cards in their individual areas, or if the cards are dealt by the dealer into a center area, as shown in FIGS. 1e, 1i and 1j, may vary. As still another variation, the players may be dealt their first and second cards into their individual areas, but the third card may be dealt into a center area and shared by all players, as shown in FIGS. 1k and 1l. In yet another variation, the dealer may deal one set of cards into a center area and the card may be shared by all players, as shown in FIGS. 1m and 1n. A skilled reader will recognize that a wide range of configurations of the gaming table and individual player areas may be incorporated in embodiments of the present invention.

In one embodiment of the present invention the casino-style gaming table may have a surface that is wholly or partly sensitive to interaction with a player. For example, the wager areas may have touch-sensitivity whereby a player may indicate a wager by way of touch contact with the wager area. The card areas may further be interactive, whereby the value of a particular card may be apparent to the table by way of interaction with a particular card. In this manner activities during the play of the game may be indicated to a main controller, such as a dealer, by way of interaction with the gaming table. A skilled reader will recognize the wide variety of interactive means whereby a table may be configured to facilitate recognition of steps of the play of the game by a controller.

In yet another embodiment of the present invention players may be remotely located from the gaming table. Remote play may occur through gaming devices and such play may be against other players engaging in play on a gaming device, against themselves, or remote play may also be against players at a gaming table. In this embodiment the interaction between the players at the table and the interactive sensitive portions of the gaming table may be indicated to the remote player. Additionally, the activities of the player on the gaming device may be indicated to the players at the table by way of the interactive portions of the gaming table.

For example, the values of the cards dealt on the gaming table upon the interactive sensitive card areas on the table may be revealed to the remote player on the gaming device. Wagers by players at the gaming table may be indicated to the remote player on the gaming device. Additionally, wagers of the remote player may be achieved through use of the gaming device, but may additionally be indicated to the players at the gaming table through indicators on the gaming table. A skilled reader will recognize that a variety of means may be utilized to achieve interactive play of the game between remote players and players at a gaming table that is equipped with interactive sensitivity.

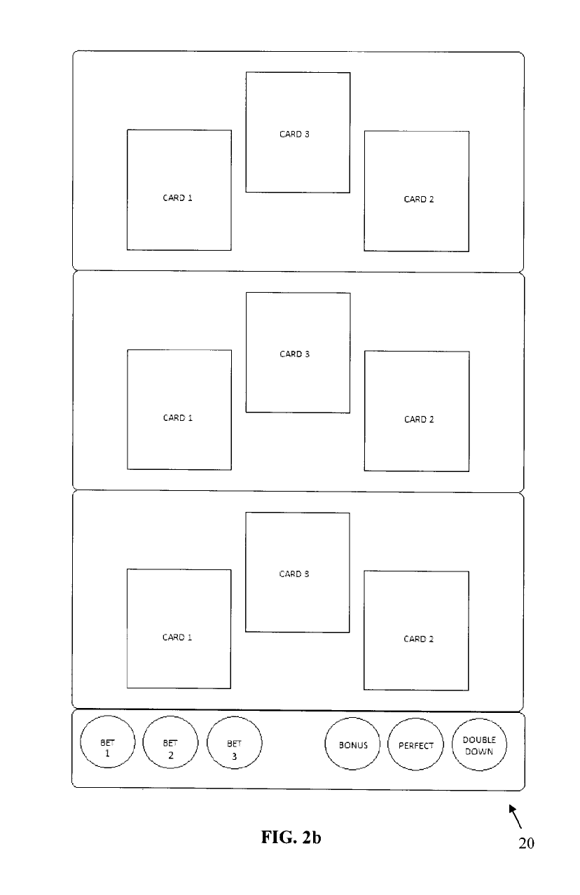

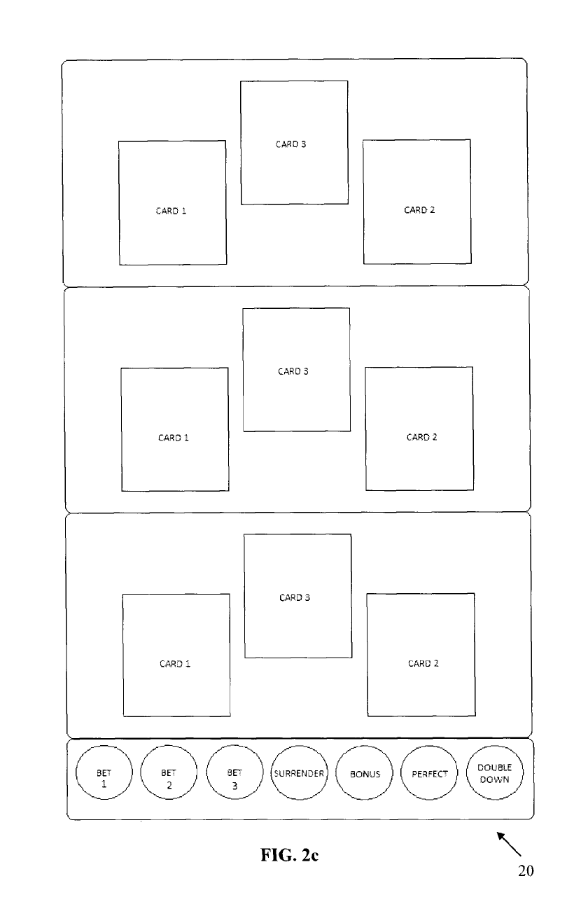

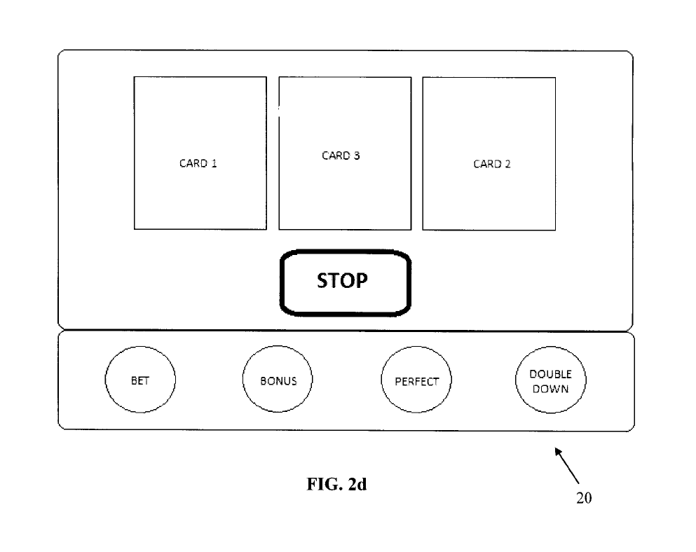

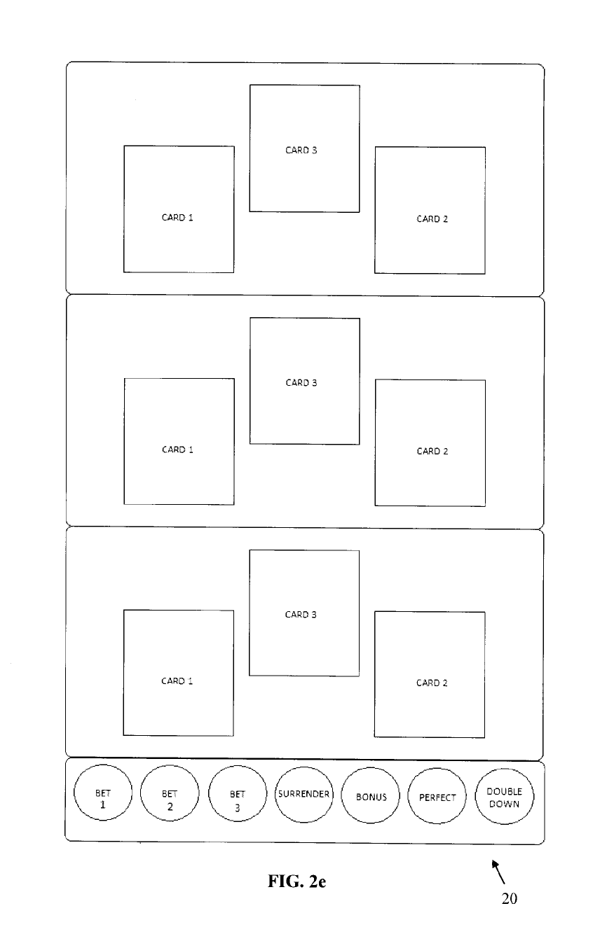

The present invention is capable of being implemented on gaming machines, video machines, computer terminals, mobile devices, home entertainment systems and other electronic devices. Examples of configurations of such electronic devices 20 are shown in FIGS. 2a-2e. Each electronic device may facilitate the display of one of the configurations or may facilitate the display of multiple configurations. A configuration for an individual player is shown in FIG. 2a. Card areas and wager areas in this configuration may be touch sensitive, as may be facilitated by a touch screen, sensitive to a mouse, typed command, voice command or other manner of communication. Such communication may facilitate activities related to the game play, such as making a particular type of wager. In some embodiments of the present invention commands may indicate other activities as well, such as requesting a card, or other commands.

The configuration shown in FIGS. 2b and 2c permit a player to play multiple hands and make wagers relating to each hand. The hands may be played simultaneously in the same manner as would occur for multiple players in a game. Alternatively, the hands may be played in a subsequent manner, whereby once one full hand is completed, the next hand may be dealt. As yet another alternative, the first two cards may be the same for all hands, but the third card may be different for each hand. Thereby the player may play three consecutive hands, but based upon the same first two cards. These variations on the game may be applied to the gaming table as well. In specific embodiments of the present invention that include such variations the surrender wager option may not be offered to a player on all hands, as shown in FIG. 2b, or particular hands, whereas a surrender option is offered in the embodiment shown in FIG. 2c.

FIG. 2b shows a multi-action embodiment of the game of the present invention. In this variation of the game, the player may make upto three bets and may further have an option for a bonus wager. The first and second cards may be randomly drawn by an electronic means, such as a means controlled by a Casino machine. The same first and second game cards may be utilized for all games of the multi-action game. In Game 1 the player may have the option to double down, or to play based upon an initial wager. Once the double down option is chosen or declined and any initial wager is placed, a third card is drawn by an electronic means and displayed to the player. Two additional games (Game 2 and Game 3) may be played using the same first and second cards, but having a third card dealt by an electronic means based upon the card being randomly chosen. In each game the player has the same option to double down or play against the initial wager, as is described for the first game. A surrender option may not be provided in this embodiment of the game. This version of the game may be played in a variety of mediums, such as, for example electronically, as a table game, or as a Casino machine game.

FIG. 2c shows a multi-action embodiment of the game of the present invention during which a player may begin by making up to three bets and may have an option to make a bonus wager. In the manner described above, the first and second cards for each of three games may be randomly drawn by an electronic means, and these same first and second cards will be utilized for all three games. As Game 1 starts the player may have the option to surrender, to double down, or to play against an initial wager. Once the options have been accepted or declined the third card is randomly chosen by an electronic means and is shown to the player. Game 2 and Game 3 follow the same steps as Game 1. This version of the game may be played in a variety of mediums, such as, for example electronically, as a table game, or as a Casino machine game.

FIG. 2d shows another variation on the game of the present invention that may be applied through an electronic device. In this variation of the game the first and second cards may be randomly drawn by an electronic means. The third card may be generated to show a succession of cards which change constantly in order from lowest to highest card (e.g. in order from Ace to King). When the player sees a card of a value between the values of the first and second cards he may communicate to the game to stop. The third card will be shown to be the card being displayed when the electronic device processed the stop command. As discussed above, the player may communicate with the electronic device in a variety of manners. Payouts for the version of the game may alter in relation to the difficulty of the game. For example, if a first card has a value of 7 and the second card has a value of 10, the difficulty of causing the third card to stop at a card of a value of 8 or 9 may be deemed high and therefore the payout may be 5 to 1. Bets and wagers that may be applied to this game are include all of the betting and wager options described for other embodiments of the game, and any combination of the betting and wagering options may be applied or all of the betting and wagering options may be applied to this embodiment of the game of the present invention. This variation of the game is best suited to be played on an electronic gaming means or a Casino machine, although a skilled reader will recognize that other gaming environments may be suitable for this variation of the game.

Yet another variation of the game of the present invention is shown in FIG. 2e. A player may begin by making a single initial wager and may also have an option to make a bonus wager. A first and second card may be randomly drawn and shown as dealt to the player. At this point Game 1 starts and the player has the option to make a surrender wager, double down, or play based upon the initial wager. After the player makes his option at this stage the third card is shown. The player then as the option to continue and play a second hand. The first card of Game 2 may be shown. A player may select a second initial wager. The second card may then be shown to the user. At this point the player has the option to surrender, double down, or play based on the second initial wager. After making his selection of an option the third card may be shown. The player has the option to play a third game based upon a third initial wager in the same manner as Game 2.

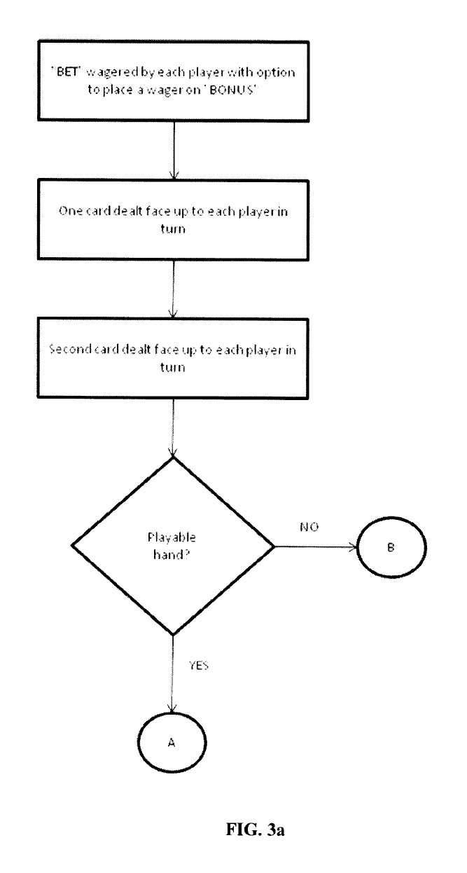

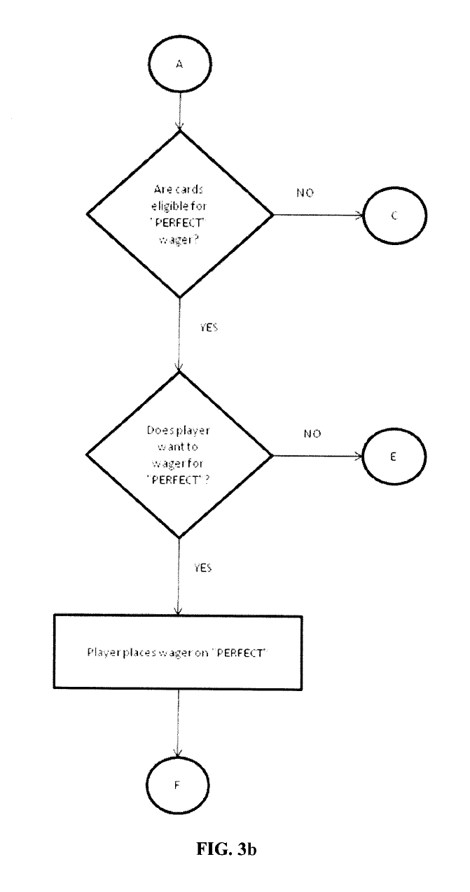

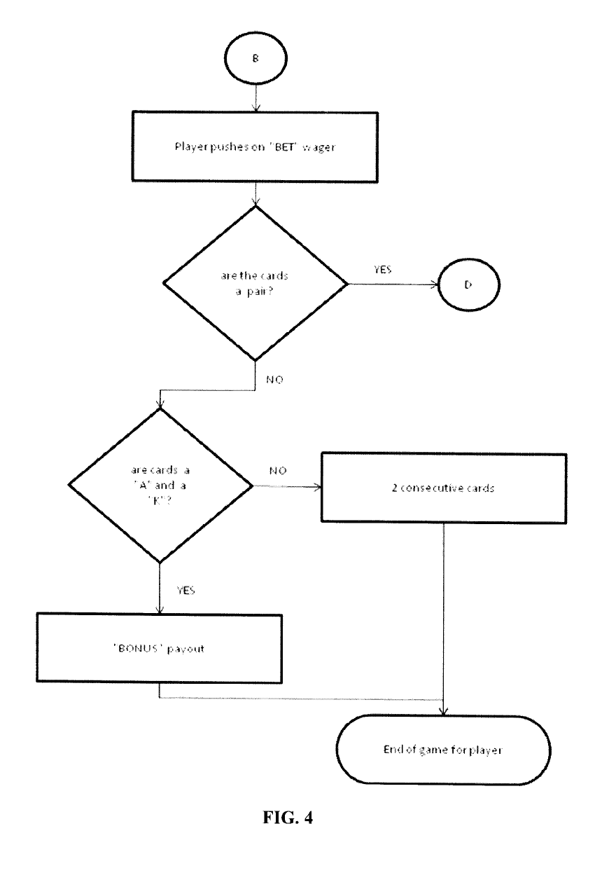

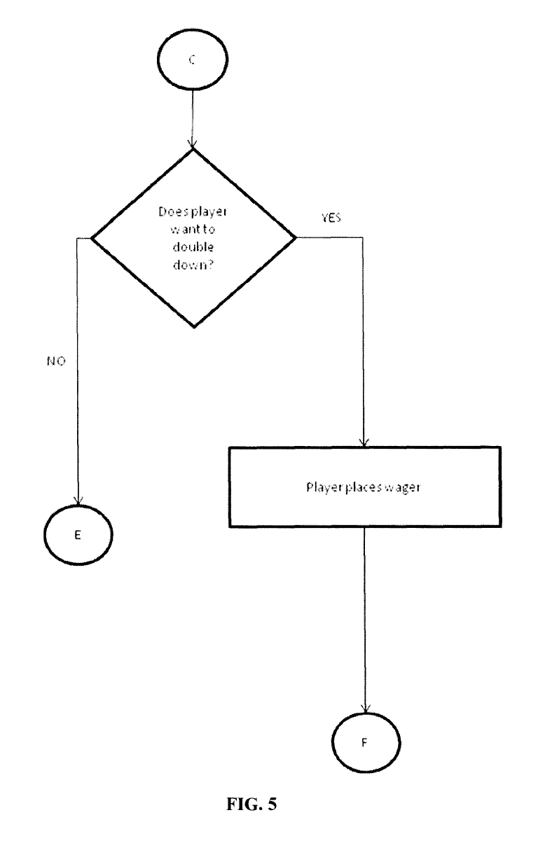

Variations upon the game of the present invention may alter the order of play. Examples of the order of play are shown in FIGS. 3-9. Generally, at the beginning of each game, each player has the option to place an initial wager. Each wager may be indicated in the form of chips, tokens, coins, bills, or other communication of the wager as may be indicated in any corresponding wager area, as may appear on an electronic device of gaming table. For example, an initial wager may be indicated in an initial wager area, which may be marked by “BET” or some other marking. In some embodiments of the present invention a minimum for the initial wager may be set prior to play commencing. In additional to placing an initial wager, a player may also have the option to place a bonus wager.

Once each player has placed a wager, the dealer then a first card is dealt face up to each player in turn. Subsequently, a second card is also dealt face up to each player in turn. Based upon the first and second cards dealt to him, each player must determine if he has a playable hand. A playable hand may be one that the player believes offers him a favourable probability of winning based upon any of his wagers. In order to win generally, the value of the third card dealt face up to the player must fall between the values of the first and second cards that were previously dealt to the player.

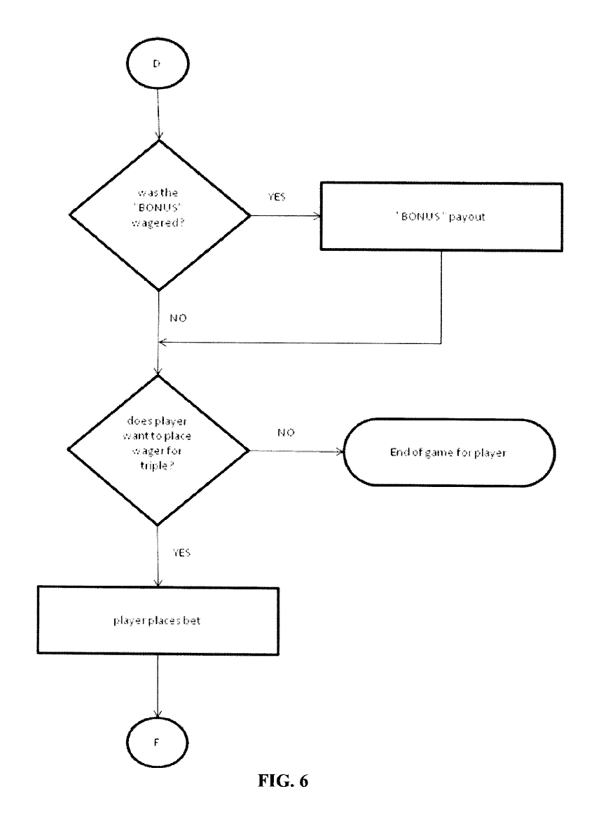

If the hand is deemed by the player not to be playable the player may indicate the option not to play the hand, as shown in FIG. 4. Such communication may be made through a variety of means as discussed above. If the player has made a bonus wager then the dealer will determine if the hand is one that wins the bonus wager. A hand may win the bonus wager if it is a pair or an Ace/King combination. If the hand is not a combination of Ace/King or a pair the game may end for the player.

If the combination of the first and second cards dealt to the player is an Ace and King then the player will be paid on a bonus wager payout. This is the only hand where an initial wager and bonus wager may be paid to the player. At this point the game may end for the player.

If the first card dealt and second card dealt to the player are the same and are therefore a pair then the player will be paid the bonus wager payout and the player will take back their initial wager (also called a “Push”) in this case. A bonus wager may be collected or paid out prior to a third card being dealt to a player.

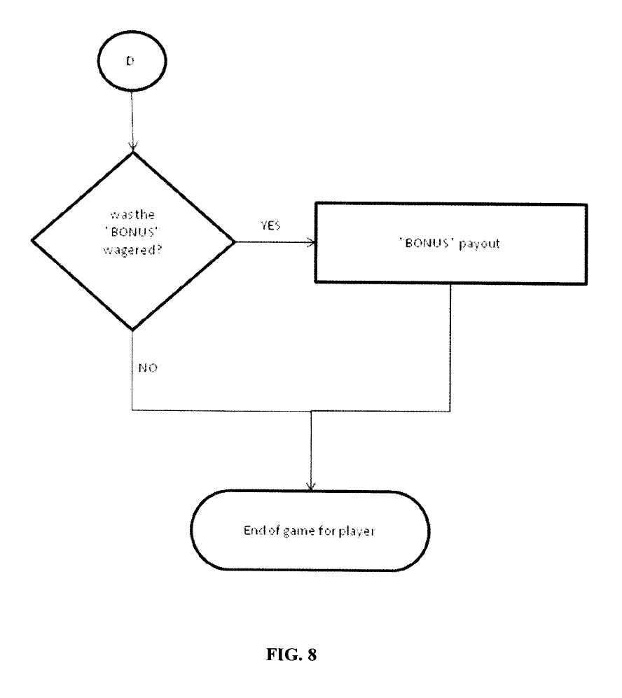

After the bonus wager payout is completed for a pair, as shown in FIG. 8, the game may end for the player.

Alternatively, as shown in FIG. 6, the player may choose to make a triple bonus wager. The triple bonus wager option may be available in various versions of the game, including electronic versions of the game. If the player does not choose to make a triple bonus wager the game may end for the player.

The triple wager option provides a benefit over the prior art, in that many prior art games end when the player has cards that are not playable. The triple wager option may permit a player of the present invention to continue play even when the player's cards are not playable. In this manner embodiments of the present invention that include the triple wager option may permit a game within a game.

In an embodiment of the present invention it may not be necessary that a bonus wager be wagered in order for a player to play the triple wager bonus game. The player may have an option to play the triple wager bonus game even if he did not play the original bonus game.

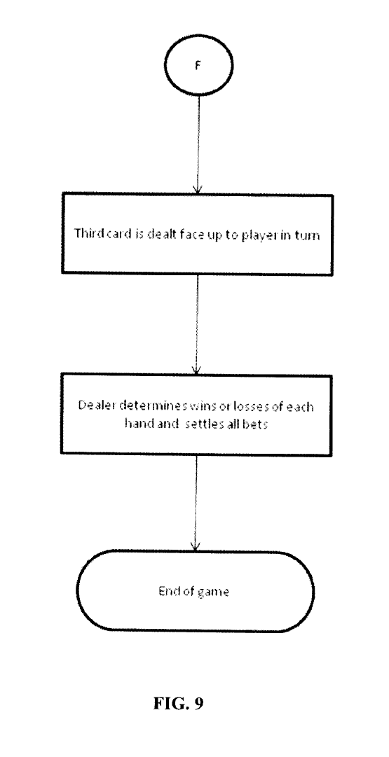

If the player chooses to make a triple bonus wager, a third card may be dealt face up to player, as shown in FIG. 9. Based upon the value of this third card the dealer may determine the wins or losses of the hand of each player and may settle all bets based upon this determination. All triple bonus wagers should be placed before the third card is dealt, as shown in FIG. 6. At this point the hand may end.

A hand may be deemed to not be a playable hand by a player for example if the first and second cards are consecutive values. For example, if a first card is a value of 5, and the second card is a value of 6. If the cards are neither an Ace/King combination nor a pair, the player may not be eligible for any bonus wager payout. As shown in FIG. 4, the player may take back his initial wager (also called a “Push”). At this point the hand may end.

If the player believes that they have a “playable hand”, he may have multiple options to increase his risk/return tolerance.

One such option may be to make a perfect wager. The method for playing the perfect wagering option is shown in FIG. 3b. Once the player deems that he has a playable hand, he will evaluate if the cards are eligible for a perfect wager. For example, if the first card is a value of 10 and the second card is a value of 8, then a perfect wager can be placed—with the player aiming for a third card having a value of 9 to be dealt to him.

If the player wants to play for the perfect wager he may place his wager on the position labeled as corresponding to the perfect wager, as may be available on either an electronic device or a gaming table.

Alternatively, the player may choose not to make a perfect wager, even if he is eligible to do so. The player may communicate this choice to the game through a variety of means which may depend on whether he is playing at a gaming table, if the gaming table is interactive, or whether he is playing via a remote electronic device. These possible communication means are discussed above.

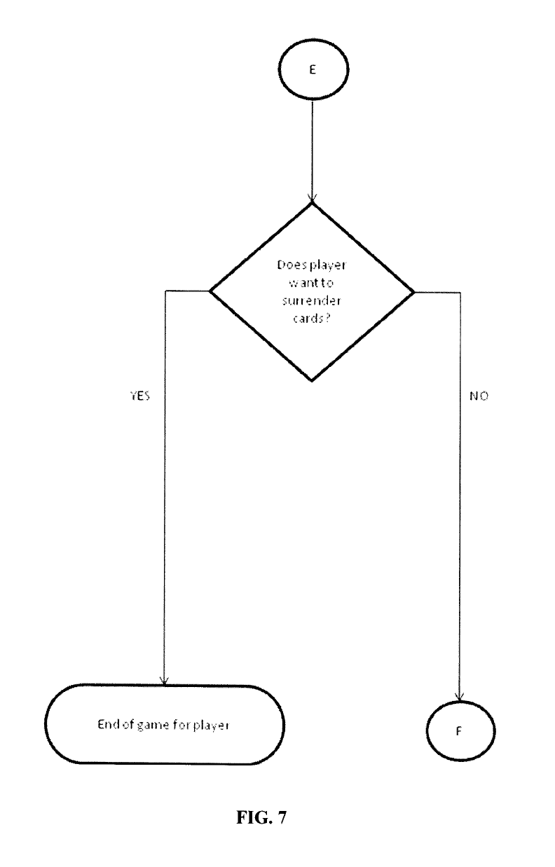

If the player does not believe they have a high probability of winning a perfect wager, he will have the option to surrender and take back half his initial wager, as shown in FIG. 7. By allowing each of the players a “surrender” option at this point, the present invention offers players an opportunity to recoup half their initial wager, even after the player has seen both cards dealt to them. If the player chooses to surrender then game will end at this point for the player. The surrender option is available for all versions of the game, including any electronic version of the game.

If the player either places a perfect wager or does not choose to surrender, a third card may be dealt face up to player, as shown in FIG. 9. Based upon the value of this third card the dealer may determine the wins or losses of the hand of each player and may settle all bets based upon this determination. At this point the hand may end.

An alternative option may be available to a player if he is not eligible to make a perfect wager based on the first and second cards that were dealt face-up to the player. If the player believes that the value of the third card dealt will fall between the first and second card values, he can maintain his initial bet and have the option of making a double-down wager, as shown in FIG. 5. If the player decides to make a double down wager this wager can be equal or less than his initial wager. A double down wager may be indicated on a wager area corresponding to a double down wager in the same manner as other wagers may be indicated. A player may not make a double down wager if his first and second cards are eligible for the perfect wager option.

If a player does not decide to make a double down wager he may have the option to surrender and take back half his initial wager, as shown in FIG. 7. By allowing each of the players a “surrender” option at this point, the present invention offers players an opportunity to recoup half their initial wager, even after the player has seen both cards dealt to them. If the player chooses to surrender then game will end at this point for the player.

If the player does not make a double down wager or surrender he may maintain his initial wager.

If the player either places a double down wager or does not choose to surrender, a third card may be dealt face up to player, as shown in FIG. 9. Based upon the value of this third card the dealer may determine the wins or losses of the hand of each player and may settle all bets based upon this determination. At this point the hand may end.

If a player is dealt first and second cards that represent a pair, then the player may be offered the option to split the cards. If the cards are split then essentially the player may play each card as one card in a separate game. Consequently, each of the first pair may be considered to be the first card dealt for each of two individual bets that are now being played by the player. A second card can be dealt for each individual bet, and should one or more of the second cards create another pair further splitting may occur. The player may play each individual bet created by splitting as separately from the other bets.

The spilt option may provide a benefit of the present invention over the prior art. Known in-between games do not generally offer the option to split a pair. The ability to split a pair offered by the present invention therefore offers an added chance to a player to place additional wagers when the split option is chosen by the player. This can increase the odds that the player will play a winning hand.

An electronic version of the present invention, such as may be played on a mobile device, may be played in accordance with a computer program operable to provide a game environment and player options. A skilled reader will recognize that the a computer program written to facilitate the play of the present invention may be of a variety of types and include a variety of elements, such as means of representing the playing environments (e.g., representations of the playing surface, representations of the playing cards, representations of dealing of the cards, means by which a player may communicate an intention to accept one or more options offered to the player, etc.). The following details represent one possible embodiment of a computer program relating to the present invention.

A computer program for an embodiment of the present invention may include the rules of play, such as the initial wager and other wager options, or splitting, that may be part of the present invention, as described herein. The computer program may be further undertake to determine the options available to a player and the next steps of the game as well as a probability distribution. The probability determination may indicate the likely activities of a player and may be achieved by cycling through and playing out all possible player hands, in accordance with the rules of play. Such a computer program may undertake the following steps:
An analyzer that is part of the computer program may cycle through all of the possible two-card hand combinations that may be presented to a player.
For each hand either a player's expectation may be determined, as may be the options of play available to a player and the next steps of play or termination of the game. A player's expectation may be determined to represent the player's average return. Each hand may be recognized by the computer program and addressed by a set of steps, such as:
i) if the two-card hand is not a pair or two consecutive cards the computer program may undertake one or more assumptions that may influence further processing and subsequent steps of the computer program. For example, the computer program may make the following determinations:
   a) a player's expectation should the player surrender (ev_sur);
   b) a player's expectation should the player double down (ev_dd);
   c) a players expectation when he player plays the game based on the initial wager (ev_ini);
   a third card may then be drawn from the cards remaining in the deck (which may be more than a single deck of 52 cards, as described herein). A counter of the present invention may count the frequency of the third card being between the first two cards of the two-card hand and mark as a win (e.g., mark as wn), as well as the frequency of the third card not being between the first two cards of the two-card hand and mark as a loss (e.g., mark as ls).
   The computer program may undertake calculations based upon the information it gathers, and may produce certain results, such as, for example, the following:

ev_{—}sur=−0.5

ev_{—}dd=2*(wn*Pay−ls)/(Decks*Num−2)

ev_{—}ini=(wn*Pay−ls)/(Decks*Num−2)
In such calculations Pay may represent the pay out of the base game.
The computer program may recognize the largest value of the values determined by the program, for example, such as the value represented in the calculations above. Based upon which value is the largest the computer program may expect certain activities by the player. For example, if the largest value is ev_sur the payer should surrender; if the largest value is ev_dd the player should double down; and if the largest value is ev_ini the player should play the game based on the initial bet. The computer program may add the largest value to the player's expectation that is determined based on the two-card hand.
ii. if the two-card hand is a pair the computer program may offer the player the opportunity to split the hand, and if the player accepts the option to split the hand the program may undertake one or more assumptions that may influence further processing and subsequent steps of the computer program. For example, the computer program may make the following determinations:
   a) a pair (e.g. a pair of cards of which each card is a card i) can cause the computer program to compute the expectation of the two-hands that result from the split of the pair that was the initial two-card hand.
   For the first hand of the split pair the computer program may cause a card to be drawn from the remaining cards in the deck (which may be more than a single deck of 52 cards, as described herein) (e.g., card j & Decks*Num−2).
   b) if card i and card j are not a pair and not two consecutive cards, the computer program may operate to draw a card from the remaining cards in the deck (e.g., Decks*Num−3) as a third card of the hand (e.g, card k). The computer program may identify the card as a win or loss, based on whether the card is between the cards i and j, as described in section i) described above. The computer program may cumulate the frequency of the player's wins, losses and pushes for the hand.
   c) if i and j are a two consecutive cards then a push may occur. The computer program may draw a card from the remaining cards in the deck (e.g., card k & Decks*Num-3). If the i and k are two consecutive cards another push may result. Otherwise the computer program may cause a card to be drawn from the remaining cards in the deck (e.g., Decks*Num-4) as a third card and the computer program may identify the card as a win or loss, based on whether the card is between the cards i and k, as described in section i) described above. The computer program may cumulate the frequency of the player's wins, losses and pushes for the hand.
   Subsequently, or simultaneously, the computer program may cause a second card for the second hand to be drawn from the remaining cards in the deck and may undertake steps to determine the next steps available to a player based upon the second card, as described herein in section i) and section ii).
   The computer program may determine the expectation of a split hand, and may assume the expectations of each hand (e.g., a hand split once may be represented ev1 and ev2). The expectations may be utilized in a calculation to determine the optimal strategy of play (e.g., if (ev1+ev2)>0 the optimal strategy may be to split. The larger of 0 and (ev1+ev2) may be added to the player's expectation for the game). The determinations of possible next steps for a player may be generated to a player as player options. The player can communicate his or her choices of play to the computer program. The computer program may interpret these communications and undertake the next steps in the game, or terminate the play, in accordance with the communications.
iii) if the two-card hand includes two consecutive card, then the player expectation may be calculated or represented as 0. The computer program may go through all of the two-card hand combinations to determine the expectation of the player and the house edge.

In some embodiments of the present invention it may only be possible to split one pair, and a second pair that occurs based upon a card that was part of a first pair may cause a push to be the only acceptable response. In other embodiments a limited number of splits may be possible, or an unlimited number of splits may be possible.

As described herein, embodiments of the present invention may be operable to support various forms of gaming and play. For example, embodiments of the present invention may support live play, online gaming, a mobile gaming device, a handheld gaming device, a smart phone or mobile App, a home video gaming system, or any other forms of gaming and play. Some embodiments of the gaming and play of the present invention are described herein. Systems that include a link to the Internet or to one or more servers may be operable to achieve interactive play amongst multiple remote players. The interactive play may be real-time or near real-time play. A skilled reader will recognize that other forms of gaming and play may be possible in accordance with the invention.

### Online Gaming System

One embodiment of the present invention may be an online gaming system that includes one or more servers linkable with the Internet (or an intranet, or other networked environment). The servers may be operable to store one or more computer programs or other software of the present invention. The servers may further be linkable to one or more devices that may incorporate one or more computer processors that may be operable to process the computer programs. The devices and the Internet (or intranet, or other networked environment) may further be an element of the online game system of the present invention.

Interaction between the elements of the system may be initiated by a player, or other user, who may communicate to the device a request to download the computer programs of the present invention or other software. To comply with this request the device may create a link to the Internet. Through the Internet link a connection with one or more servers may be achieved and the servers may be operable to transfer the computer programs and/or software to the device, so that the computer programs and/or software may be downloaded to the device, or to the Internet. Generally, the transfer will involve the operation of the server that is closest to the player's Internet protocol address.

In some embodiments of the present invention, elements, portions or all of the computer programs and other software, may be stored in the device after a transfer. In other embodiments of the present invention, the transferred computer programs and other software may not be stored in the device. A skilled reader will recognize that the Internet connection, server and device may communicate parts of the whole of the computer programs and other software of the present invention, and that these parts may be downloaded to either the Internet or device in a permanent or non-permanent manner, and that storage of these parts may be shared amongst the device and the servers.

In order to access and utilize the computer programs and/or other software the player may be instructed through the device, which may be a computer or any other Internet or other network access capable device, to input a user name. The player may further be required to provide other information, such as a password or other information. The user name and other information may be stored in the one or more servers. Upon the player inputting the user name and any other required information, this information may be communicated to the server (e.g., such as through the Internet) and a verification process may be undertaken by the server, to verify that the user name and any other required information inputted by the player is valid and represents a valid player of the present invention. In embodiments of the present invention the user name, required information or details, and other information or details may be stored in one or more database linked to or contained in the one or more servers.

If the player has not previously accessed the computer programs or other software of the present invention, the computer programs or other software may function to require the player to register. The registration process may require the player to provide at least a user name, and may further require that the player provide other required information or details. The user name and other required information or details may be communicated to the server to be utilized by a new player verification process to verify that the user name and any other information or details are unique to the player and are not assigned to any other player.

If the result of the new player verification process is that the user name and any other required information or details is already assigned to another player, then the failure of the registration process may be communicated to the player through the device. This communication may be in a variety of forms, such as a warning message, or other communication. The player may be provided by operation of the computer program with another opportunity to input another user name and any other required information or details. A new player verification process may occur utilizing the user name and any other required information or details in the manner described herein. In some embodiments, the present invention may set a limit of registration attempts. Upon the limit of registration attempts being reached without a successful verified registration of a user name and any other required information or details unique to the player the system may close and the player may be unable to activate the registration process for a period of time.

If the result of the new player verification process is that the user name and any other required information or details is not already assigned to another player, then the user name and any other required information or details may be stored in the server as relevant to this player. As described herein, the stored user name and any other required information or details may be utilized to verify the player for future sessions of the system of the present invention. In embodiments of the present invention, a verified access to the system may be communicated to the player, such as, for example by a message or other communication.

A player may enter information or details besides the user name and any required information or details. This information details (that is not the user name or any required information or details) may also be stored in the server as relevant to the player, as part of the player's account. Also information pertaining to the player, the play of the game, or any data collected by the present invention, may be collected by the system and stored to the server as relevant to the player at various times during the function of the present invention and the player's engagement with the present invention. Stored information, details or data may be accessed for a variety of purposes by the system, such as, for example reporting, wager redemptions, or any other purpose.

A player may choose an option for the type of play, such as “free play”, credit play, or money play. The choice of the player may be communicated to the computer program and generate operation of the computer program as follows:
if the free play option is chosen by the player, the computer program may be operable to calculate the wagers and wins or loses of the player, but will not base these amounts on money or credits. No money or credits will be owed to or from the player when the close option is chosen by the player to end the gaming session.
if the credit play option is chosen by the player, the computer program may be operable to calculate any money amounts won by the player at the end of individual games or the session and to convert these amounts into credits. The conversion rate may be pre-determined and either accessed by the computer program from the server or from a specified Internet site identified in the computer program. The credit amount may be stored to the server as relevant to the player. The credits may be utilized by the player for future games, or may be converted into prizes or other rewards by the user. The use of credits or conversion of credits may be in accordance with predetermined use rates or conversion definitions as may be accessed by the computer program from the server or from a specified Internet site identified in the computer program. Alternatively, a player may access a specified Internet site that is linked to the server outside of game play and may use or convert credits through that Internet session.
if the money play option is chosen by the player, the computer program may access information or other data stored on the server that are relevant to the player and undertake an account verification process to verify that the player has transferred money to a player money account or provided information to generate access to an amount of money. For example, money may be made accessible through the player money account by way of the provision of authorization to charge money to a credit card, transfer of money through a money transfer means, such as, for example a PayPal™ account or a debit card. Once the account verification process verifies that sufficient money to initiate play is available in the account the player may initiate a gaming session. Otherwise, if the account verification process fails to verify either that sufficient money to initiate play is available in the account or that the player does has not generated an account, then the player may be required to generate an account and provide access to money. A skilled reader will recognize that a variety of means of creating the player money account may be applied by operation of the computer program. In some embodiments of the present invention the account verification process may include steps to match the player with the money provided, such as, for example matching some or all of the player profile details with the details of a credit card provided by the player. Other steps may also be included in the computer program to avoid fraudulent activities by a player. Additionally, embodiments of the present invention may include steps in the verification process to verify the maximum limit of money available through the player money account. The maximum limit may be the maximum limit of a credit card, a maximum limit set by a player that is supported by the money access the player provided (e.g., the maximum limit is either less or equal to the amount of money transferred to the present invention by the player, or is less or equal to the maximum limit of the credit card, etc.). This maximum limit may be referenced by the computer program throughout play whenever the player wagers money, and the computer program may be operable to provide a warning to the player when a wager is offered that is beyond the maximum limit or cumulatively causes the amount of money owing by the player to the game to be beyond the maximum limit. The computer program may require the wager to be retracted or for the maximum limit to be increased and to be supported by the provision of additional money or be within the credit card maximum limit before the wager will be accepted. At the end of the gaming session, or at one or more points in time during the game play, money owing by the player may be transferred from the player money account to an account of the present invention. The transfer may be by charge to the credit card, by wire transfer of funds from the player money account or an account that the player has provided the present invention with access to, or by other means. At the end of the session of gaming, the computer program may calculate money owing by the present invention to the player based on overall winnings of the player. Money owing to the player may be recorded by the present invention, such as, for example, in the server as relevant to the player. The money owing to the player may be transferred to the player in multiple ways. For example, all or some of the money owing to the player may be transferred to the player from an account of the present invention based upon a request by the player that is communicated to the present invention, or an Internet site related to the present invention that is authorized to access the servers of the present invention. As another example, money owing to the player may be transferred to the player from an account of the present invention at the end of the gaming session, or at one or more points during gaming play. The transfer of money to a player may be to the player directly through a pre-determined direct payment means that may be selected by a player prior to the payment, or may be directed to the player money account or any payment means (such as, for example a bank account, a credit card, or other payment means) identified by the player money account.

In embodiments of the present invention, a verified access to the system may cause the system to install an icon onto the device, such as, for example, onto the desktop of the device.

The icon may be accessed, such as, for example through a touch or the click of a mouse, and the access of the icon may activate the computer program and any other software of the present invention. In some embodiments of the present invention, accessing the icon may cause the central processing unit of the device to boot and the device to be connected to the Internet, and the Internet to be connected to the servers. This connection of device, Internet and servers may be required for the operation of the system of the present invention.

The computer programs and any other software may present elements to facilitate the play of the “in-between” game described herein. For example, such as the buttons required to play the game, including a bet button, a bonus button, a push button, a deal button, a split button, etc. The button representations may be accessed through touch, or click of a mouse, etc. Embodiments of the present invention may represent the options of play to players through elements other than options.

Some embodiments of the present invention may communicate the buttons to the player throughout the game, while other embodiments of the present invention may communicate the buttons at the points in play when each button may be applicable to the play, as described herein. For example, a split button may only be communicated to a player when the split option is available, or a split button may always be communicated to a player but may only be utilized when the split option is available to a player. It may also be possible in embodiments of the present invention for some buttons to have multiple purposes, so that a button may facilitate the selection of a split option by a player at one point of play and the same button may facilitate selection of a different option by a player at a different point of play when a different option is available to a player, such as a push option. A skilled reader will recognize the variety of configurations for presenting the game and options of the game to a player and receiving a communication of the options selected by a player during game play.

Selection of options may be communicated by a player through interaction with the device, and the option selection may be communicated to the computer program or any other software of the present invention that is operable to achieve particular activities based upon the communicated option to permit game play to be achieved. The computer programs and any other software of the present invention may undertake calculations upon receiving communications of options selected by the player, such as the option to have cards dealt to the player. Upon the deal option being communicated by the player to the device, the computer program may cause the representation of two cards, which represent randomly dealt cards, to be provided to the player through the device. In one embodiment of the present invention the computer processors of the device may cause the computer program and any other software to calculate an inputted allowable winning percentage and may distribute the cards based upon this calculation.

In embodiments of the present invention the computer programs may further determine if a player has an automatic win or is eligible for another option based upon the two cards dealt and represented to the player through the device. A determination by the computer programs may occur after each card that is dealt and each option selected by the player, to identify the next steps of the game that may be provided to the player to facilitate the game play.

The computer programs may store any calculations or determinations occurring during interaction between the player and the present invention in the servers as relevant to the player, and/or as relevant to the present invention generally. As described herein, this stored information may be utilized for many purposes, including calculating statistics relating to the present invention based on interaction with the present invention by multiple players.

A player may be provided with the option to close the interaction with the present invention. This option to close may be provided to the player throughout the player's interaction with the present invention, or a certain points. When a player selects the close option, any information or other details to be stored to the server may be transferred to the server and stored in the server. The links and other connections between the device, the Internet and the servers may be closed or broken.

### Smart Phone or Mobile Phone App System

In another embodiment of the present invention, the system may be a smart phone or mobile phone App system. The elements for this embodiment of the present invention may include one or more servers linkable with the Internet (or an intranet, or other networked environment) or directly with the phone. The servers may be operable to store one or more computer programs or other software of the present invention. The phone may be linkable with the Internet.

A link may be generated between the phone and the Internet, either through activity of the player or automatically based upon processors of the phone. The link between the phone and the Internet may allow the player to transfer communications from the phone to the Internet. Through such communications the user may access the Internet on the phone, such as, for example an App store or a web portal. The player may communicate through the phone, a request to the Internet to transfer software to the phone. Based upon the communication the Internet may access the computer programs and any other software of the present invention from the servers and transfer this to the phone. The transfer may occur in a manner similar to that described herein for the online gaming system.

In some embodiments of the present invention, elements, portions or all of the computer programs and other software, may be stored in the device after a transfer. In other embodiments of the present invention, the transferred computer programs and other software may not be stored in the device. A skilled reader will recognize that the Internet connection, server and device may communicate parts of the whole of the computer programs and other software of the present invention, and that these parts may be downloaded to either the Internet or device in a permanent or non-permanent manner, and that storage of these parts may be shared amongst the device and the servers. In one embodiment of the present invention the connection may be solely between the server and the phone once the computer programs and any other software of the present invention is transferred to the phone.

The computer programs may be operable to require registration by a player, and the registration process may be similar to that described for the online gaming system, although the communication of information may be between the phone and the servers directly, or may be through a link between the phone, Internet and the servers. The transfer of information between the computer programs and the servers may also be similar to that described herein for the online gaming system, in that calculations, determinations, information or other details may be provided to the present invention, or derived by the present invention and may be stored to the servers, either as relevant to the player, or as relevant to the present invention generally. Any information, other details, calculations, determinations or other data may be stored to one or more database linked to or contained in the servers.

A player may choose an option for the type of play, such as “free play”, credit play, or money play, and the choice and the operations of the computer program to achieve these options may be similar to those described for the online gaming system.

Upon a successful registration process the computer program may be operable to transfer an icon to appear on the phone screen. A user may activate the icon in a variety of manners, including through touch if the phone has a touchscreen. The icon may be operable to activate the present invention in a manner similar to that described herein for the online gaming system, although the communication of information may be between the phone and the servers directly.

The computer programs may provide a representation of the elements of the game to the player through the phone. As described for the online gaming system, these elements may include buttons or other option representations that may be accessed by the player to communicate selection of options by the user during game play. The elements may be configured specific to the size and the communication options of the phone (e.g., touch sensitive elements, configured keys of a keyboard to indicate specific selections of options by a player, size of the gaming elements, colour variety of elements, etc.). Embodiments of the phone App system may appear differently to the player based upon the type of phone that the player is utilizing (e.g., a Blackberry™, an iPhone™, a cell phone, etc.). A skilled reader will recognize the means by which the computer programs may be operable to accommodate a variety of phone types, either through a selection of computer programs transferred to the phone, or through the operation of the computer programs upon a specific phone type.

The phone App system may also close in a manner similar to that described herein for the online gaming system, with the option that the process may occur between the phone and the servers directly.

### Handheld Electronic Gaming System

In yet another embodiment, the present invention may be a handheld electronic gaming system that includes a hand held unit. The hand held unit may incorporate a screen, central processing unit of one or more computer processors (CPU), random access memory (RAM), flash memory, a user interface and an operating system. The flash memory may store the computer programs and any other software of the present invention. The flash memory may also be operable to store game data before, after and/or during play of the game. The RAM may be operable to store temporary information relating to the player and/or the play of the game. The operating system may be the environment wherein the computer programs operate.

The user interface may provide a means whereby elements of the game are represented to the player by way of the screen. The user interface may also be operable to accept communication from the player, such as selection of options, by way of either interaction with the screen (e.g., touch of a touch screen) or other means, such as selection or pushing of buttons or options representations. Buttons in particular may be provided as representations on the screen, and/or be physical buttons integrated into the hand held unit. Buttons integrated into the hand held unit may be pushed to indicate selection of options or other communications to the computer programs. Other representations on the screen may be selected by a player by other means, such as, for example touching or clicking upon the representation. A skilled reader will recognize the variety of means by which a player may communicate with the computer processors and thereby with the computer programs.

The player may be restricted to the “free play” options as described herein for the online gaming system if the handheld electronic gaming system is not connectable to the Internet. If the handheld electronic gaming system is an embodiment of the present invention that is connectable to the Internet and/or to one or more servers of the present invention, in a manner similar to that described for the online gaming system, the player may also be provided with the option to choose credit play, or money play, and the choice and the operations of the computer program to achieve these options may be similar to those described for the online gaming system.

The selections may influence the operations of the computer programs in a manner similar to that discussed herein for the online gaming system. For example, the computer may undertake specific calculations or determinations based upon the selections, options or other communications by the player. The computer program may operate the flow of the game play. Some calculations, determinations, information, details or other data communicated by the player or generated through the operation of the computer program may be stored in the flash memory, before, after or during game play. Other calculations, determinations, information, details or other data communicated by the player or generated through the operation of the computer program may be stored to the RAM. Calculations, determinations, information, details or other data stored to the RAM may be stored on a temporary basis to be used for operations of the computer programs, or may be stored on a longer basis through transfer to the flash memory. In some embodiments of the present invention, a transfer of some calculations, determinations, information, details or other data from the RAM to the flash memory may occur based upon a communication of the player that generates a transfer process by the computer processors in accordance with the computer programs of the present invention.

### Video Gaming System

Still another embodiment of the present invention may be a video gaming system that incorporates a video gaming unit, such as, for example a Playstation 3™, an XBOX 360™, a Nintendo Wii™, etc. and a software storage means, such as, for example a flash drive, a DVD Blu-Ray Disc™, or other storage means. The computer programs and other software of the present invention may be stored on the software storage means. The software storage means may be connected or otherwise linked to the video gaming unit so that the computer programs of the present invention are accessible by the video gaming unit and may be processed by the processing unit of the video gaming unit. The video gaming unit may further be linked or otherwise connected to a screen, which may be any type of screen, such as for example a touch screen and/or a 2D screen, or a 3D screen, etc. The video gaming unit may further be linked or otherwise connected to an input device, such as, for example a joystick, a Wii™ controller, a keyboard, a computer mouse, or any other input device. The input device may be operable to accept communications from a player and transfer these communications to the video gaming unit and then to the computer processors and the computer program, so that the computer program is operable in accordance with the communications from the player.

The video gaming unit through the operation of its processing unit operable in accordance with the computer programs accessed from the software storage may represent elements of the game to the player by way of the screen. The user interface may also be operable to accept communication from the player, such as selection of options, by way of either interaction with the screen (e.g., touch of a touch screen) or other input devices. Buttons in particular may be provided as representations on the screen, and/or be physical buttons integrated into the input device. Buttons integrated into the input device may be pushed to indicate selection of options or other communications to the computer programs. Other representations on the screen may be selected by a player, such as, for example by touching or clicking upon the representation. A skilled reader will recognize the variety of means by which a player may communicate with the computer processors and thereby with the computer programs.

The selections may influence the operations of the computer programs in a manner similar to that discussed herein for the online gaming system. For example, the computer programs may undertake specific calculations or determinations based upon the selections, options or other communications by the player. The computer programs may operate the flow of the game play. In some embodiments of the present invention, some calculations, determinations, information, details or other data communicated by the player or generated through the operation of the computer programs may be stored in memory of the video gaming unit, or any hard drive linked or otherwise connected to the video gaming unit, either temporarily or more long-term.

The player may be restricted to the “free play” options as described herein for the video gaming system if the video gaming system is not connectable to the Internet.

Initiating the game play may be achieved through a player communication through the input device and the computer program operating in response to that communication. The closing of the game play may also be achieved through player communication through the input device and the computer program operating in response to that communication.

### Video Gaming Unit Linked to the Internet

In yet another embodiment the video gaming system, the video gaming unit may be liked to the Internet, to create an Internet video gaming system. A skilled reader will recognize that this embodiment of the present invention may function in the manners described herein as operabilities of the video gaming system and the online gaming system. For example, the computer program may not be required to be transferred from a remote server but may be accessed from the software storage, and the calculations, determinations, information, details or other data communicated by the player or generated through the operation of the computer programs may be stored in a server accessible through the Internet.

A player may choose an option for the type of play, such as “free play”, credit play, or money play, and the choice and the operations of the computer program to achieve these options may be similar to those described for the online gaming system.

It will be appreciated by those skilled in the art that other variations of the embodiments described herein may also be practiced without departing from the scope of the invention. Other modifications are therefore possible.

1. A method of an in-between game playable upon an electronic device, wherein a player is provided with multiple options to wager characterized in that the method comprises the steps of:
(a) the player making one or more pre-dealing wagers prior to any cards being provided to the player;
(b) providing at least two cards to the player; and
(c) the player determining if the at least two cards represent a playable hand, resulting in the player communicating a request to take one or more of the following steps: pushing; splitting; making a post-dealing wager; or surrendering.

2. The method of claim 1, characterized in that the method further comprises the step of making one or more pre-dealing that include at least one of the following: an initial wager; and a bonus wager.

3. The method of claim 1, characterized in that the method further comprises the step of making one or more post-dealing wagers that include at least one of the following: a triple bonus wager; a perfect wager; and a double-down wager.

4. The method of claim 1, characterized in that the method further comprises the step of interacting by way of the electronic device to participate in the game with live players.

5. The method of claim 1, characterized in that the method further comprises the step of playing the game by way of a mobile device, an Internet connected device, a gaming console, a home entertainment system, a smart phone, a mobile phone, or a wireless device.

6. The method of claim 1, characterized in that the method further comprises the following steps:
(a) providing a one or more cards to the player upon the player communicating any of the following requests: pushing, splitting, or making a post-dealing wager, and repeating this step if the player communicates the option splitting; and
(b) determining a win or a loss of the game by the player.

7. The method of claim 6, characterized in that the method further comprises the steps of:
(a) calculating any monies owing to the player based upon the one or more pre-dealing wagers and one or more post-dealing wagers; and
(b) transferring the monies owing to the player money account.

8. The method of claim 6, characterized in that the method further comprises the steps of:
(a) calculating any monies owing by the player based upon the one or more pre-dealing wagers and one or more post-dealing wagers; and
(b) transferring the monies from the player money account.

9. An online gaming system for playing an in-between game involving multiple wager options, characterized in that the Internet gaming system further comprises:
(a) one or more servers operable to store data; and
(b) a device including a screen and an input means operable to access an online connection and further linked to the one or more servers, said device further being operable to function with the one or more servers to:
(i) transfer data from the one or more servers to the device to operate the in-between game to:
(1) offer one or more pre-dealing wagers to a player prior to any cards being provided to the player and to communicate the one or more pre-dealing wagers chosen by a player to the server application;
(2) provide at least two cards to the player; and
(3) accept a request communication from the player, upon the player determining if the at least two cards represent a playable hand, to take one or more of the following steps: pushing; splitting; making a post-dealing wager; or surrendering.

10. The online gaming system of claim 9, characterized in that it further comprises storing data communicated by the player through the input means to the one or more servers as player data.

11. The online gaming system of claim 10, characterized in that it further comprises the in-between game being operable to access the player data and utilize the data in a verification process to register or log-in the player to a gaming session.

12. The online gaming system of claim 9, characterized in that it further comprises money being won or lost by the player during the game and, data stored in the one or more servers in a player money account providing access details whereby transfer of monies to or from the player, in accordance with money won or lost by the player, is achieved through the online connection.

13. A computer program product tangibly embodied on a computer readable medium, for use on a server computer, characterized in that the computer program product comprises:
(a) a computer useable medium; and
(b) computer readable program code recorded or storable in the computer useable medium, the computer readable program code defining a server application on the server computer that is operable on the server computer to:
(i) offer one or more pre-dealing wagers to a player prior to any cards being provided to the player and to communicate the one or more pre-dealing wagers chosen by a player to the server application;
(ii) provide at least two cards to the player; and
(iii) accept a request communication from the player, upon the player determining if the at least two cards represent a playable hand, to take one or more of the following steps: pushing; splitting; making a post-dealing wager; or surrendering.

14. A method of playing an in-between game wherein a player is provided with multiple options to wager, characterized in that the method comprises the steps of:
(a) one or more pre-dealing wagers being made by the player prior to any cards being provided to the player;
(b) providing at least two cards to the player;
(c) the player determining if the at least two cards represent a playable hand, resulting in one of the following steps:
(i) determining the at least two cards are not a playable hand and a determining one of the following actions based on the at least two cards and the one or more pre-dealing wagers:
(1) making a pre-dealing wager payout to the player and ending the game; or
(2) ending the game;
(ii) determining the at least two cards are a playable hand and taking the following steps:
(1) providing the player with the option to make one or more post-dealing wagers; and
(2) dealing at least one additional card to the player; and
(3) determining any wager payout to the player, or losses by the player, based upon the at least two cards, the at least one additional card, the one or more pre-dealing wagers and the one or more post-dealing wagers, having one of the following results:
(a) making a payout to the player; or
(b) receiving payment from the player.

15. A method of claim 14 comprising the further step of playing the game upon a device or surface having interactive capabilities whereby the user may communicate activities of the game with the device or surface through a communication means.
